(19) United States
(12) Patent Application Publication
(10) Pub. No.: US 2015/0139210 A1
(43) Pub. Date: May 21, 2015

(54) METHOD AND APPARATUS FOR ACCESS PARAMETER SHARING

(71) Applicants: Janne Marin, Espoo (FI); Jukka Pekka Reunamäki, Tampere (FI); Sverre Slotte, Esbo (FI); Niko Tapani Kiukkonen, Veikkola (FI)

(72) Inventors: Janne Marin, Espoo (FI); Jukka Pekka Reunamäki, Tampere (FI); Sverre Slotte, Esbo (FI); Niko Tapani Kiukkonen, Veikkola (FI)

(73) Assignee: Nokia Corporation

(21) Appl. No.: 14/408,179

(22) PCT Filed: Jun. 29, 2012
(86) PCT No.: PCT/FI2012/050694

§ 371 Date: Dec. 15, 2014

(51) Int. Cl. H04W 48/16

(52) U.S. Cl. CPC H04W 48/16
USPC 370/338

(57) ABSTRACT

In a non-limiting and example embodiment, a method is provided for access parameter sharing. An access point receives a first message from a second apparatus, the first message comprising an information element indicating if access credentials may be requested for the access point. The apparatus determines, based on the first message, whether access credentials of the access point may be requested. In response to detecting that the access credentials may be requested, the apparatus transmits a request message for requesting the access credentials of the second apparatus. The access credentials are received from a third apparatus, different from the access point.

### FIELD

The present invention relates to sharing of access parameters.

### BACKGROUND

Local wireless networks, such as IEEE 802.11 WLANs or wireless wide area networks, are very widely used for Internet connectivity. Majority of private wireless network access points are protected, i.e. they can be hidden and require correct encryption key to be accessed. Various personal communications devices like mobile phones, tablets and laptops are having more and more nomadic users who use their devices increasingly at friends' homes, pubs, cafes and soon also e.g. in private cars. A cellular data connection can be slow, expensive and/or may not be supported.

### SUMMARY

Various aspects of examples of the invention are set out in the claims.

According to a first embodiment, there is provided a method, comprising: receiving, by an apparatus, a first message from a second apparatus, the first message comprising an information element indicating if access credentials may be requested for the second apparatus, determining, based on the first message, whether access credentials of the second apparatus may be requested, in response to detecting that the access credentials may be requested, transmitting a request message for requesting the access credentials of the second apparatus, and receiving the access credentials from a third apparatus, different from the second apparatus.

According to a second embodiment, there is provided a method, comprising: receiving, by an access point, a first request message from a non-access point apparatus, transmitting a first response message to the non-access point apparatus, the first response message comprising an information element indicating whether access credentials of the access point may be requested via the access point, after transmission of the first response message, receiving by the access point from the non-access point apparatus a second request message for requesting the access credentials, and transmitting a third request to a third apparatus for transmitting the access credentials to the non-access point apparatus.

According to a third embodiment, there is provided an apparatus configured to carry out the method of the first and/or second embodiment.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a wireless communications system;

FIGS. 2a and 2b illustrate methods according to some embodiments;

FIGS. 3a and 3b illustrate information elements according to an embodiment;

FIG. 4 illustrates network information sharing architecture according to an embodiment;

FIG. 5 illustrates a method according to an embodiments; and

FIG. 6 illustrates a mobile communications device according to an embodiment.

### DETAILED DESCRIPTION

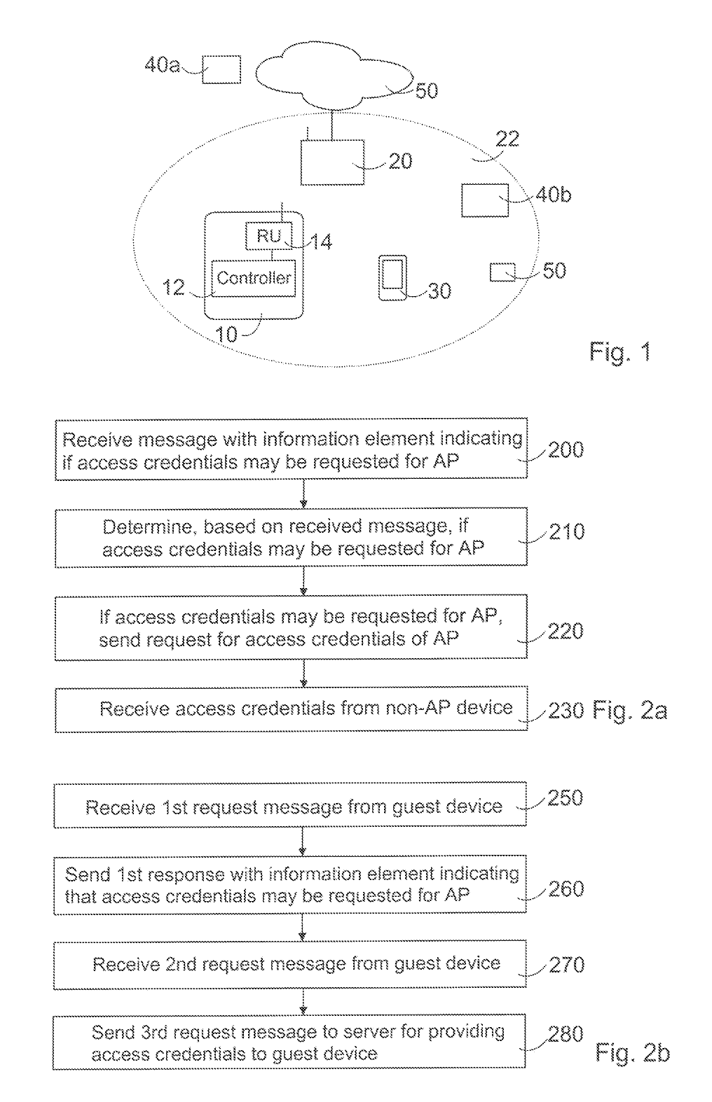

FIG. 1 illustrates an example of a wireless communication system including radio devices, such as devices supporting IEEE 802.11 features. While some wireless network sharing related embodiments are described below with reference to WLANs, it should be appreciated that other embodiments are applicable to sharing access to other wireless networks, such as wireless personal area networks (WPAN), wireless peer-to-peer networks, wireless mesh networks, wireless wide area networks (WAN).

Mobile devices 10, 30 may associate with an access point (AP) or a base station 20. In some embodiments, the devices 10, 30 are IEEE 802.11 WLAN stations (STA) capable of establishing an infrastructure basic service set (BSS) with the AP 20. The AP 20 may be a fixed or mobile AP. The AP 20 typically provides access to other networks 50, e.g. the Internet. In another embodiment, an independent BSS (IBSS) or a mesh BSS (MBSS) is established without a dedicated AP, and in such embodiments the mobile device 10, 30 may be a non-access-point terminal station. There may also be other WLANs or other types of access networks, such as cellular networks, available for the devices 10, 30, via which remote devices 40a, such as network servers, may be connected. One or more further local devices 40b, in the examples below also referred to as server, may be connected to a locally available wired or wireless network. The system may also comprise other devices, such as tags or sensor nodes 50.

The mobile device 10, referred hereafter as the guest device, may be visiting a coverage area 22 of the AP 20, which may be owned by a user of mobile device 30, hereafter referred as the owner device.

Credentials for accessing a WLAN by establishing a connection with the AP 20 may comprise at least one of a service set identifier, an encryption type indicator, and an encryption key. A Bluetooth address needed for connecting Bluetooth device is an example of a parameter for accessing a WPAN. However, it is to be noted that these are just examples of applicable parameters and the term ‘access credentials’ is not limited to access parameters of any particular network. An owner of a wireless network often is not willing to share his network and credentials due to security concerns, does not know the required credentials or is not aware how to setup connection credentials into a device. Most people do not want to open their network in order to maintain privacy, to avoid increased traffic on their internet connection or to protect from false accusations of piracy. Some advanced access points support separate guest access but these are not very common. Some expert users also set up a guest network with additional routers and access points. A password protected guest network still requires its owner to share the credentials to guests. It is generally desirable to have an easy and trusted method to give access to protected wireless networks, such as WLAN access points. It may be possible for the owner to authorize or delegate at least some wireless network sharing functions and access credentials provision to another apparatus, such as the server 40a, 40b. However, a user of a guest device 10 often does not know which of the locally visible networks guest access is controlled by such other apparatus and how to get access to such network.

According to some embodiments of the present invention, access points capable of network sharing send for guest devices 10 an information element indicating that access credentials may be requested for the AP 20.

FIGS. 2a and 2b illustrate methods according to some embodiments. These methods of FIGS. 2a and 2b may be applied as control algorithms in apparatuses, such as the guest device 10 and the AP 20 in the example embodiments below, respectively.

A network information message is received 200 from the AP 20, the message comprising an information element indicating if access credentials may be requested for the access point. Based on this information element, the guest device 10 may become aware of the possibility of requesting access to a non-open/secured WLAN. Furthermore, based on this message, the guest device 10 may get information on how the access may be requested for such WLAN, e.g. an identifier of a server 40a, 40b or the owner device 30 controlling network sharing and/or providing the access credentials for the AP 20.

The message may be a (first) response to a (first) request message transmitted by the guest device 10 before block 200, this embodiment being illustrated in connection with FIG. 2b. In another embodiment, the network information message 200 is a broadcast message, such as a WLAN beacon frame.

The guest device 10 determines 210, on the basis of the received message, whether access credentials of the access point may be requested. After detecting that access credentials may be requested, a request message for requesting access credentials is transmitted 220. The request may be transmitted to the AP 20 or the third device identified in the received message from the AP 20. It is to be noted that there may be further actions before transmitting the request message. For example, the user of the guest device may need to be informed of the network access option, and a confirmation of the user for connecting to such network may be required if automatic connection establishment has not been set.

The access credentials are received 230 from a third apparatus, different from the AP, such as the server 40a, 40b. The wireless network provided by AP 20 may then be accessed based on the received access credentials. In an embodiment, the access credentials are stored to a protected storage, such that the stored credentials are accessible by only predetermined trusted application(s), such as lower level connectivity management software.

In some embodiments, the guest device 10 determines 220, based on the received message, whether access credentials of the AP 20 may be requested via the AP 20. If yes, the guest device 10 sends the request message to the AP 20 for requesting the access credentials via the AP 20. This embodiment is also illustrated in FIG. 2b, in which the AP 20 receives 250 a first request message from a non-access point apparatus, such as the guest device 10 in the example embodiments below.

In response to the first request, the AP 20 transmits 260 a first response message to the guest device 10. The first response message comprises an information element indicating whether access credentials of the access point may be requested via the AP 20.

The AP 20 receives 270 from the guest device 10 a second request message for requesting the access credentials. In response to the second request message, the AP 20 may transmit 280 a third request message to a third device, such as the server 40a, 40b, for transmitting the access credentials to the guest device 10. The third request message may be an authorization message or a network sharing control message authorizing the third device to send the credentials to the guest device 10.

It is to be noted that there may be further actions before transmitting 280 the third request message. In an embodiment, the AP 20 is configured to check if the guest device is authorized to access the wireless network 22 and get the access credentials. In an alternative embodiment, the AP 20 forwards the request from the guest device 10 to the server 40a, 40b responsible for access control. In response to the third request message, the third device may send the access credentials to the guest device 10.

The first request message 250 may be broadcasted or addressed to a locally detected AP 20. The first request may be a network information request or more specific request for network access credentials.

In some embodiments, the first request message 250 is a probe request or a generic advertisement service (GAS) request frame and the first response message 200, 260 is a probe response or a GAS response frame.

The (second) request message transmitted 220, 270 by the guest device 10 to request the access credentials via the AP 20 may be a probe request or a GAS request frame. However, it will be appreciated that these are merely examples of applicable frames.

A new information element may be included in the beacon and/or probe response frame to indicate at least whether access credentials of the access point may be requested for/via the AP.

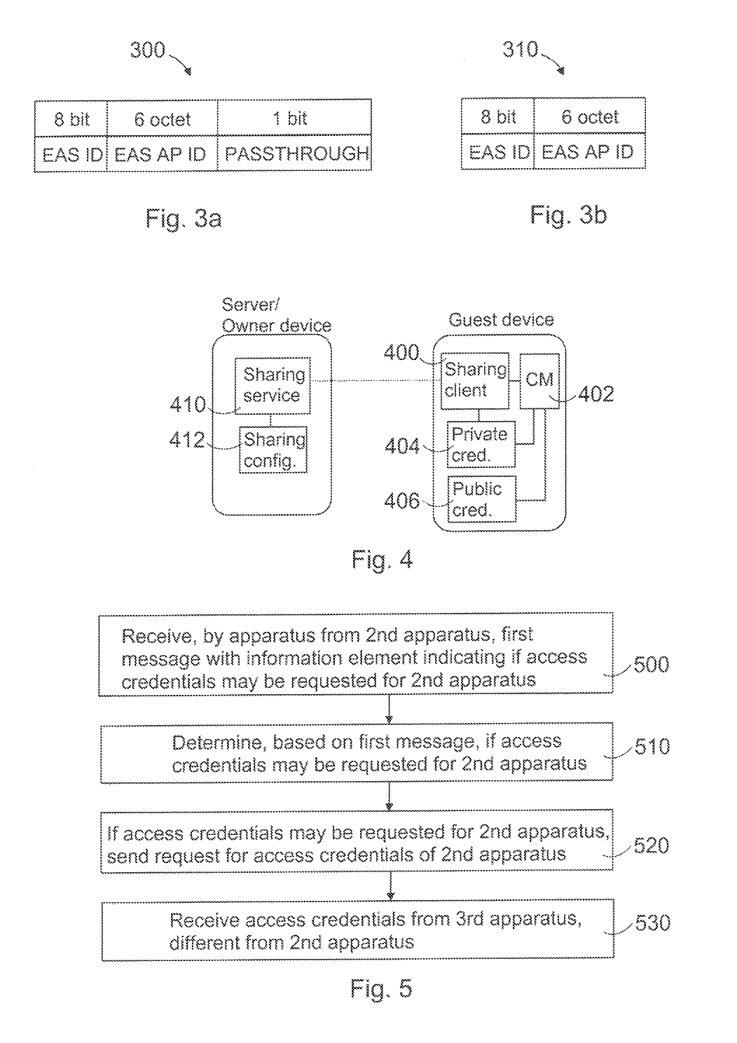

FIG. 3a illustrates an example of such information element. An easy access sharing (EAS) ID identifies that this IE belongs to a network sharing related application, which may be referred as the EAS application, for example. The EAS AP ID identifies uniquely the AP in EAS context. A PASSTHROUGH parameter may be included in the first (response) message to indicate if access may be requested via the access point 20. If this is set, a sharing client in the guest device 10, which may be referred to as an EAS client, may be able to use the AP, otherwise not.

The new information element may be specified as a standard information element in the IEEE 802.11 beacon frame format, or as a vendor specific extension to Beacon frames. In further example embodiments, the access point credential request indication is included in an information element included by Wi-Fi Protected Setup (WPS) or Wi-Fi Alliance (WFA) Certified Passpoint features to Beacon frames (as vendor specific extension or other information element).

The EAS client of the guest device 10 may be configured to determine whether the access credentials may be requested for the access point and include a client identifier in the request message 220. In response to detecting the access credentials availability indication from the AP, e.g. the PASSTHROUGH parameter, the EAS client detects that the AP is EAS capable. The EAS client may thus add a specific information element to a probe request to request 220 the access credentials. In another embodiment, a public action frame may be applied for this purpose.

An example 310 of such EAS client information element is shown in FIG. 3b. When the AP 20 receives such EAS client IE 310, it may forward the EAS client user identifier along with an AP identifier to the third device 40a, 40b, 30, such as an EAS server. The server may then configure the EAS client in the guest device 10 with the access credentials according its rules for configuration.

It will be appreciated that various other information related to connection establishment and/or access credentials acquisition may be delivered between the guest device and the AP 20. For example, the information element from the AP 20 may include information on connectivity options for the devices (e.g. indicate that access credentials are available by cellular connection), AP position information, etc. The access credentials may thus be received from the third device 40a, 40b, 30 via a radio interface other than a WLAN interface. For example, the access credentials may be received via another local connection, such as a Bluetooth or NFC connection, or a cellular connection, such as a 3GPP (Third Generation Partnership Project) or 3GPP2 based connection.

Referring again to FIG. 1, the mobile device 10 may comprise a controller 12 connected to a radio unit (RU) 14. The controller 12 may be configured to control at least some of the features illustrated above and in connection with FIG. 2a. An apparatus comprising the controller 12 may also be arranged to implement at least some of the further related example embodiments illustrated below.

With reference to FIG. 4, the mobile device 10 functioning as the guest device, and the controller 12 thereof, may encompass a sharing client 400, e.g. the EAS client capable of communicating with the EAS capable AP 20 by sending and receiving EAS information elements. The sharing client 400 is arranged to receive 210 the access credentials and store 220 the credentials to the protected storage 404. The sharing client 400 may also control access to the stored credentials. Such private wireless network parameters 404 may be separated from public wireless network parameters 406, such as guest's own WLAN and open WLANs.

The client application 400 may communicate with a sharing service/server application 410, such as the EAS server, in the server 40a, 40b or the owner device 30. The sharing service application 410 may collect the network credentials which are delivered for the sharing client 400. The sharing service 410 may maintain sharing configuration at least for the AP 20. In some embodiments, the client application 400 receives the credentials directly from the sharing service application 410.

The sharing client application 400 may inform a user of the guest device 10 of available wireless networks. The sharing client application 400 may request the credentials from the sharing service 410 after receiving 200 the first response message from the AP 20. The sharing client application 400 may be arranged to automatically take care of any necessary actions for obtaining and setting the required wireless network access configuration, and trigger establishment of a connection to the AP 20. This substantially facilitates use of protected networks for non-professional users.

There may also be a further sharing owner application communicating with and controlling the sharing service/server application 410 in the server 40a, 40b and delegate wireless network credentials sharing for the sharing service application 410. Such sharing owner application may send wireless network sharing related parameters, such as the network credentials, allowed guest device identifiers and further sharing control parameters, to the sharing service application 410. There may also be an AP sharing application capable of uploading AP information, such as credentials, to the server and/or the owner device 30. It is to be appreciated that there are also many other options for implementing the network sharing control features in centralized or distributed manner.

In some embodiments, the AP 20 and/or the third device, such as the server 40a, 40b or the owner device 30, perform access control operations on the basis of the information 210, 250 from the guest device 10. The sharing service application 410 may be configured to check if the guest device 10 comprises a trusted sharing client application 400 before proceeding with network sharing. Authorization of the guest device 10 to access the wireless network is checked based on received identification information and access control information. This check may be performed automatically by checking if an identifier of the guest device is in a pre-stored list of authorized devices, and/or prompting the user of the owner device to determine if the guest device is authorized.

If the guest device 10 is authorized to access the wireless network, access credentials may be transmitted to the guest device, or identification information of the guest device is transmitted 280 to the third apparatus further applied for controlling access to the wireless network. The server may notify the owner device 30 that the network access is shared for the guest device.

In an embodiment, the server 40a, 40b maintains information to which devices/users the network access credentials have been distributed. The owner device may modify access rights and/or network credentials later. The changes are reflected to the devices having network access, such as the guest device 10.

In some embodiments, access to the received access credentials is controlled in the guest device 10. Such private credentials may be stored to a protected storage 404, e.g. by applying encryption, hidden storage area, or access-controlled storage area/position. The credentials may be accessible by only predetermined trusted applications, such as a trusted network sharing client application and lower level connectivity management software 402. In particular, the credentials may be stored such that they are not made visible in the user interface of the guest device 10. This enables to provide reasonable trust for the wireless network owner that the credentials cannot be forwarded to unauthorized parties.

In some embodiments, the access credentials are transferred in encrypted form. The owner device 30 or the AP 20 may send a decryption parameter to the server 40a, 40b, which may send it later to the guest device 10 for decrypting the encrypted credentials. In an alternative embodiment, the owner device 30 sends the decryption parameter directly to the guest device 10.

The server 40a, 40b may control the use of the shared access credentials on the basis of sharing parameters received from the owner device 30, and may send sharing control information and/or commands to the guest device 10 together with the access credentials 230 and/or in a subsequent message. For example, the parameter(s) may comprise at least one of information indicating how long the credentials are valid, information indicating a time period during which the guest device is authorized to access the wireless network, information indicating that all or a subset of allowed devices are not any more allowed to use the credentials, and information indicating need for periodic reauthorization of the credentials. As further examples, the server may control the number of times the guest device is able to access the network before the credentials elapse, or control the commissioning of new access credentials in response to detecting change or modification of the currently applied credentials.

When the guest device 10 is no longer connected to the wireless network, the stored credentials may be removed automatically by the sharing client application 400 or the connectivity management SW 402. The credentials may be prevented from being used or removed from the protected storage 404 after detecting one or more triggers for removal, such as detecting the apparatus disconnecting from the wireless network, detecting expiry of a validity period of the credentials, and/or detecting that a credentials refreshment message or an authorization message (from the owner device or a further device controlling use of the credentials) has not been received. A predefined disconnection time period may be applied before the credentials are deleted after detecting the removal trigger, to prevent accidental removal.

The sharing service 410 may be configured to cause removal of the credentials in the guest device 10, e.g. by sending a control message for removing the credentials to the sharing client 400. A user interface of the guest device 10 and/or the owner device 30 may further provide an option for a user to cause removal of the credentials in the protected storage 404.

After removal of the credentials, the guest device 10 may need to again connect the owner device 30 or the server 40a, 40b in order to use the wireless network. The owner application 400 UI may enable the owner to set a permanent access or an access until further notice for the guest device, and if necessary, new credentials may be provided or access reauthorized by the server 40a, 40b without bothering the owner. The guest device 10 may be required to check or renew its permission from the server 40a, 40b and/or owner device 30, e.g. at defined time instants.

In some embodiments the provision of the credentials to the guest device 10 is allowed 230 after the guest device is brought to touch detection proximity to the AP 20 or the owner device 30. The touch detection proximity generally refers to sensing the devices to be very close to each other (contactless) or physically touching each other. For example, the touch detection proximity may refer to proximity enabling NFC connectivity. In an embodiment, upon detecting a user input for getting access to the WLAN, the guest device 10 may begin to search for devices in close proximity and the sharing client application may advice the user to touch the owner's device 30 with the guest device 10. In another example, the network sharing is further facilitated such that credentials are provided when the guest device 10 is detected to touch the AP 20 or the owner device 30, without requiring UI actions from the user. This may be done without having a priori knowledge on WLAN existence. According to a further embodiment, BT based proximity detection is applied for triggering sharing of the wireless network and the access credentials. The BT touch feature enables to detect another BT device in touch detection proximity, on the basis of received signal strength information (RSSI) associated with received BT responses from neighbouring BT devices.

FIG. 5 illustrates a method according to an embodiment for access parameter sharing. Blocks 500 to 530 illustrate features similar to FIG. 2a, but may be applied to detect availability of access credentials for various communications devices, such as the AP 20.

In some embodiments, the second apparatus is a non-access point device, such as the sensor node 50. Thus, the sensor node may indicate its presence to a nearby mobile device 10, and indicate 500 that access credentials for accessing stored sensor data are available from the third apparatus. Based on this received message, the mobile device may detect 510 the availability of further sensor data and the access credentials, and request 520 the access credentials from the third apparatus, such as the server 40a, 40b. By using the received 530 access credentials, the mobile device may establish an access to the sensor node to receive sensor data. For example, the access credentials may be a secret authorization code required to receive measurement sensor node data. In another embodiment, the sensor node data is received from the third apparatus, or a fourth apparatus, on the basis of the received 530 access credentials.

In another embodiment, the first message 500 is received from another than the second apparatus. Thus, the third apparatus, or a fourth apparatus, may inform that access credentials are available for the second device. For example, an access point may inform, in a beacon or some other message, that there is a sensor, which may belong to the basic service set (BSS) of the AP for which (data) access credentials may be requested.

Embodiments of the present invention and means to carry out these embodiments in an apparatus, such as the mobile device 10, 30, AP 20 and/or server 40a, 40b, may be implemented in software, hardware, application logic or a combination of software, hardware and application logic. In an example embodiment, the application logic, software or an instruction set is maintained on any one of various conventional computer-readable media. It is to be noted that at least the features illustrated in connection with FIG. 2b may be applied in devices configured to operate as wireless network access point 20, such as an IEEE 802.11 WLAN AP. In another example, a mobile terminal device, such as the owner device 30, may be arranged to operate also as a wireless network access point, and thus share a wireless network access.

In one example embodiment, there may be provided circuitry configured to provide at least some functions illustrated above, such as the features illustrated in FIG. 2a, 2b, and/or 5. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

Although single enhanced entities were depicted above, it will be appreciated that different features may be implemented in one or more physical or logical entities. For instance, the apparatus may comprise a specific functional module for carrying one or more of the blocks in FIG. 2a, 2b, and/or 5. In some embodiments, a chip unit or some other kind of hardware module is provided for controlling a radio device, such as the mobile device 10, 30.

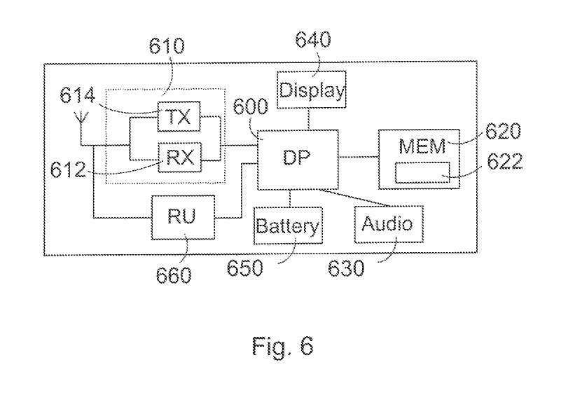

FIG. 6 is a simplified block diagram of high-level elements of a mobile communications device according to an embodiment. The device may be configured to carry out at least some of the functions illustrated above for the mobile device 10 and/or 30.

In general, the various embodiments of the device can include, but are not limited to, cellular telephones, personal digital assistants (PDAs), laptop/tablet computers, digital book readers, imaging devices, gaming devices, media storage and playback appliances, Internet access appliances, as well as other portable units or terminals that incorporate wireless communications functions.

The device comprises a data processing element DP 600 with at least one data processor and a memory 620 storing a program 622. The memory 620 may be implemented using any data storage technology appropriate for the technical implementation context of the respective entity. By way of example, the memory 620 may include non-volatile portion, such as electrically erasable programmable read only memory (EEPROM), flash memory or the like, and a volatile portion, such as a random access memory (RAM) including a cache area for temporary storage of data. The DP 600 can be implemented on a single-chip, multiple chips or multiple electrical components. The DP 600 may be of any type appropriate to the local technical environment, and may include one or more of general purpose computers, special purpose computers (such as an application-specific integrated circuit (ASIC) or a field programmable gate array FPGA), digital signal processors (DSPs) and processors based on a multi-processor architecture, for instance.

The device may comprise at least one radio frequency transceiver 610 with a transmitter 614 and a receiver 612. However, it will be appreciated that the device is typically a multimode device and comprises one or more further radio units 660, which may be connected to the same antenna or different antennas. By way of illustration, the device may comprise radio units 610 to operate in accordance with any of a number of second, third and/or fourth-generation communication protocols or the like. For example, the device may operate in accordance with one or more of GSM protocols, 3G protocols by the 3GPP, CDMA2000 protocols, 3GPP Long Term Evolution (LTE) protocols, wireless local area network protocols, such as IEEE 802.11 or 802.16 based protocols, short-range wireless protocols, such as the Bluetooth, NFC, ZigBee, Wireless USB, and the like.

The DP 600 may be arranged to receive input from UI input elements, such as an audio input circuit connected to a microphone and a touch screen input unit, and control UI output, such as audio circuitry 630 connected to a speaker and a display 640 of a touch-screen display. The device also comprises a battery 650, and may also comprise other UI output related units, such as a vibration motor for producing vibration alert.

It will be appreciated that the device typically comprises various further elements, such as further processor(s), further communication unit(s), user interface components, a media capturing element, a positioning system receiver, sensors, such as an accelerometer, and a user identity module, not discussed in detail herein. The device may comprise chipsets to implement at least some of the high-level units illustrated in FIG. 6. For example, the device may comprise a power amplification chip for signal amplification, a baseband chip, and possibly further chips, which may be coupled to one or more (master) data processors.

An embodiment provides a computer program embodied on a computer-readable storage medium. The program, such as the program 622 in the memory 620, may comprise computer program code configured to, with the at least one processor, cause an apparatus, such as the device 10, 20, 30 or the device of FIG. 6, to perform at least some of the above-illustrated network access parameter sharing related features illustrated in connection with FIGS. 2a to 5. In the context of this document, a “computer-readable medium” may be any media or means that can contain, store, communicate, propagate or transport the instructions for use by or in connection with an instruction execution system, apparatus, or device, such as a computer, with some examples of a computer being described and depicted in connection with FIG. 6. A computer-readable medium may comprise a tangible and non-transitory computer-readable storage medium that may be any media or means that can contain or store the instructions for use by or in connection with an instruction execution system, apparatus, or device, such as a computer.

Although the specification refers to “an”, “one”, or “some” embodiment(s) in several locations, this does not necessarily mean that each such reference is to the same embodiment(s), or that the feature only applies to a single embodiment. Single features of different embodiments may also be combined to provide other embodiments. If desired, at least some of the different functions discussed herein may be performed in a different order and/or concurrently with each other. Furthermore, if desired, one or more of the above-described functions may be optional.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-37. (canceled)

38. A method, comprising:
receiving, by an apparatus, a first message from a second apparatus, the first message comprising an information element indicating if access credentials may be requested for the second apparatus,
determining, based on the first message, whether access credentials of the second apparatus may be requested,
in response to detecting that the access credentials may be requested, transmitting a request message for requesting the access credentials of the second apparatus, and
receiving the access credentials from a third apparatus, different from the second apparatus.

39. The method of claim 38, wherein the apparatus determines, based on the first message, whether the access credentials may be requested via the second apparatus, and
the request message is sent to the second apparatus for requesting the access credentials via the second apparatus.

40. The method of claim 38, wherein the first message is at least one of a beacon message, a probe response and a generic advertisement service response.

41. The method of claim 38, further comprising: transmitting, by the apparatus, a first request message to the second apparatus, wherein the first message comprising the information element is a response to the first request message.

42. The method of claim 38, wherein the request message for requesting the access credentials is at least one of a probe request and a generic advertisement service request.

43. The method of claim 38, wherein the receiving the access credentials from the third apparatus comprises receiving the access credentials via a radio interface other than a wireless local area network interface.

44. The method of claim 38, wherein a passthrough bit in the first message comprising the information element indicates if access credentials may be requested for the second apparatus

45. The method of claim 38, wherein the access credentials are in encrypted form, and
the apparatus receives at least one decryption parameter from the second apparatus, the third apparatus, or a fourth apparatus for decrypting the encrypted access credentials.

46. The method of claim 38, wherein the access credentials are wireless local area network access credentials and comprise a service set identifier, encryption type, and an encryption key.

47. An apparatus, comprising:
at least one processor; and
at least one memory including computer program code,
the at least one memory and the computer program code configured to, with the at least one processor, cause the apparatus at least to:
receive a first message from a second apparatus, the first message comprising an information element indicating if access credentials may be requested for the second apparatus,
determine, based on the first message, whether access credentials of the second apparatus may be requested,
in response to detecting that the access credentials may be requested, cause transmission of a request message for requesting the access credentials of the second apparatus, and
receive the access credentials from a third apparatus, different from the second apparatus.

48. The apparatus of claim 47, wherein the apparatus is configured to determine, based on the first message, whether the access credentials may be requested via the second apparatus, and
the apparatus is configured to send the request message to the second apparatus for requesting the access credentials via the second apparatus.

49. The apparatus of claim 47, wherein the first message is at least one of a beacon message, a probe request and a generic advertisement service request.

50. The apparatus of claim 47, wherein the apparatus is configured to send a first request message to the second apparatus, wherein the first message comprising the information element is a response to the first request message.

51. The apparatus of claim 47, wherein the request message for requesting the access credentials is one of a probe request and a generic advertisement service request.

52. The apparatus of claim 47, wherein the apparatus is configured to receive the access credentials via a radio interface other than a wireless local area network interface.

53. The apparatus of claim 47, wherein a passthrough bit in the first message comprising the information element indicates if access credentials may be requested for the second apparatus.

54. The apparatus of claim 47, wherein the access credentials are in encrypted form, and
the apparatus is configured to receive at least one decryption parameter from the second apparatus, the third apparatus, or a fourth apparatus for decrypting the encrypted access credentials.

55. The apparatus of claim 47, wherein the access credentials are wireless local area network access credentials comprising a service set identifier, encryption type, and an encryption key.

56. The apparatus of claim 49, wherein the apparatus is a mobile communications terminal device comprising a transceiver and at least one antenna for communicating according to a wireless local area network standard.

57. An apparatus, comprising:
at least one processor; and
at least one memory including computer program code,
the at least one memory and the computer program code configured to, with the at least one processor, cause the apparatus at least to:
receive a first request message from a non-access point apparatus,
send a first response message to the non-access point apparatus, the first response message comprising an information element indicating whether access credentials of the second apparatus may be requested via the second apparatus,
receive apparatus from the non-access point apparatus a second request message for requesting the access credentials after transmission of the first response message, and
send a third request to a third apparatus for transmitting the access credentials to the non-access point apparatus.

58. A non-transitory computer readable memory embodying at least one computer program code, the at least one computer program code executable by at least one processor to perform a method comprising:
receiving, by an apparatus, a first message from a second apparatus, the first message comprising an information element indicating if access credentials may be requested for the second apparatus,
determining, based on the first message, whether access credentials of the second apparatus may be requested,
in response to detecting that the access credentials may be requested, transmitting a request message for requesting the access credentials of the second apparatus, and
receiving the access credentials from a third apparatus, different from the second apparatus.
